(19) United States
(12) Patent Application Publication
(10) Pub. No.: US 2012/0104824 A1
(43) Pub. Date: May 3, 2012

(54) MODULAR CONVERTABLE FURNITURE ASSEMBLY USING STACKABLE COMPONENTS

(76) Inventor: Edward Skahan, Batavia, IL (US)

(21) Appl. No.: 12/913,530

(22) Filed: Oct. 27, 2010

(51) Int. Cl. A47C 7/00; F16B 12/00

(52) U.S. Cl. 297/440.14; 312/111

(57) ABSTRACT

A modular furniture assembly includes at least two modules positioned one next to each other. The modules interconnect to each other by using a quick acting fastener and wherein groups of the same module types can stack.

### BACKGROUND OF THE INVENTION

The present invention generally relates to modular furniture. More specially, the present invention relates to a modular furniture assembly that manually combines individual modular components to create different types of furniture. In addition, each modular component has the ability to stack with other modular components of the same type.

In recent years the use of modular furniture has increased considerably. The existing modular furniture has been designed specifically to form a single piece of furniture. Unfortunately, after the final furniture is assembled, it is difficult to disassemble. Furthermore, the components that form the modular furniture cannot be rearranged to form a different piece of furniture.

As can be seen, there is a need for a modular furniture assembly that can be easily assembled and disassembled. Also, there is a need for a modular furniture assembly that allows the user to rearrange the modular components with one another to create a new arrangement of furniture. In addition, there is a need to disassemble the furniture and stack the respective components for ease of storage.

### SUMMARY OF THE INVENTION

In one aspect of the present invention, the modular furniture assembly includes at least two modules that interconnect to each other by using a quick acting fastener.

In one aspect of the present invention, the modular furniture assembly includes a plurality of modules that interconnect to each other by using a quick acting fastener, the sides of each module matches the sides of the adjacent module forming a tight bond between the modules.

In one aspect of the present invention, the modular furniture assembly includes a plurality of modules positioned one next to each other, the sides of each module matches the sides of the adjacent module forming a tight bond between the modules, and the modules are interchangeable.

These and other features, aspects and advantages of the present invention will become better understood with reference to the following drawings, description and claims.

### BRIEF DESCRIPTION OF THE DRAWINGS

FIG. 1A illustrates a perspective front view of a base module according to the present invention;

FIG. 1B illustrates a perspective bottom view of the base module of FIG. 1A;

FIG. 1C illustrates one embodiment of the present invention showing several of the base modules of FIG. 1A stacked;

FIG. 2A illustrates a perspective back view of a frame module according to the present invention;

FIG. 2B illustrates a perspective front view of the frame module of FIG. 2A;

FIG. 2C illustrates one embodiment of the present invention showing several of the frame modules of FIG. 2A stacked;

FIG. 3A illustrates a perspective front view of a back rest module according to the present invention;

FIG. 3B illustrates a perspective back view of the back rest module of FIG. 3A;

FIG. 3C illustrates one embodiment of the present invention showing several of the back rest modules of FIG. 3A stacked;

FIG. 4A illustrates a perspective back view of an arm rest module according to the present invention;

FIG. 4B illustrates a perspective front view of the arm rest module of FIG. 4A;

FIG. 4C illustrates one embodiment of the present invention showing several of the arm rest modules of FIG. 4A stacked;

FIG. 5A illustrates a perspective front view of a leg rest module according to the present invention;

FIG. 5B illustrates a perspective back view of the leg rest module of FIG. 5A;

FIG. 5C illustrates one embodiment of the present invention showing several of the leg rest modules of FIG. 5A stacked;

FIG. 6A illustrates a perspective front view of a filler module component according to the present invention;

FIG. 6B illustrates a perspective back view of the filler module component of FIG. 6A;

FIG. 6C illustrates one embodiment of the present invention showing several of the filler module components of FIG. 6A stacked;

FIGS. 7A-7D illustrate several embodiments of the present invention, the components reconfigured as a sofa;

FIGS. 8-11 illustrate several embodiments of the present invention showing the components reconfigured as a bed;

FIGS. 12A-12I illustrate several embodiments of the present invention showing the components reconfigured as a chair; and chaise lounge.

FIGS. 13A-13D illustrate several embodiments of the present invention showing the components reconfigured as a sofa.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a modular furniture assembly that allows the user to easily rearrange the components with one another to convert them into a new arrangement of furniture wherein respective components of the same type can be stacked.

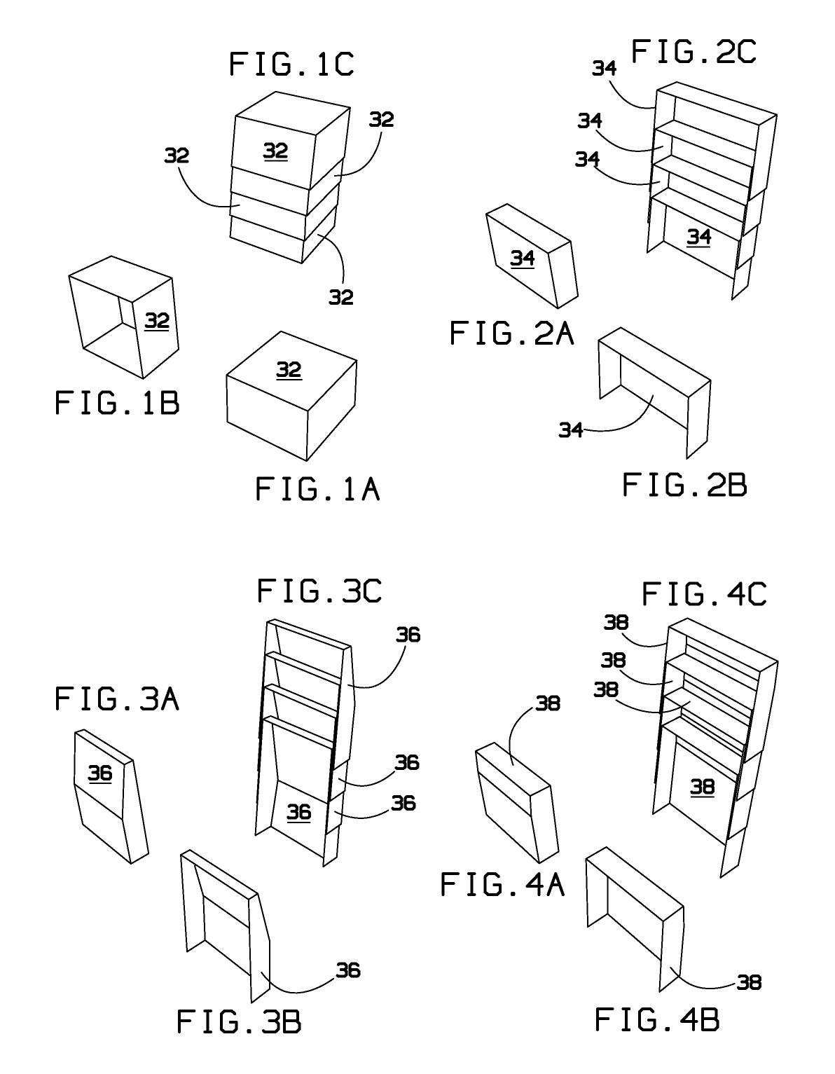

FIGS. 1A-1C show one embodiment of the present invention, on which one of the modular components may be a base module 32. The base module 32 may be the support surface that may serve as the furniture structural form to which the rest of the modular components may be attached. The base module 32 may be made of a rigid material suitable for furniture construction. In one embodiment, the base module 32 may be made of wood, plastic, metal, composite, or recycled material. The dimensions of the base module 32 may be determined by the user. In one embodiment, the height of the base module 32 may be less than half of the width of the base module 32. The shape of the base module 32 may provide stability to the furniture. In one embodiment the base module 32 may have a square or rectangular shape. In one embodiment, the base module 32 may include a plurality of legs attached to its bottom side. In one embodiment, the base module 32 may include a seat cushion 14. In one embodiment, the base module 32 may include a fabric slip cover that covers all or part of the module wherein the fabric may be made of an appropriate material for indoor or outdoor use.

FIGS. 2A-2C show one embodiment of the present invention, on which one of the modular components may be a frame module 34. The frame module 34 may be configured to provide support to the user when connected to the base module 32. In one embodiment, the frame module 34 may provide support to the arms, legs, or head of the user. The frame module 34 may be made of a rigid material suitable for furniture construction. In one embodiment, the frame module 34 may be made of wood, plastic, metal, composite, or recycled material. The frame module 34 may be placed on any side of the base module 32 to form different furniture designs. In one embodiment, the frame module 34 may be placed in front of the base module 32 to simulate a leg support. In one embodiment, the frame module 34 may be placed next to at least one side of the base module 32 to simulate an arm support. In one embodiment, the frame module 34 may be placed between two base modules 32 to form a larger surface. In one embodiment, the frame module 34 may include shelves. In one embodiment, the frame module 34 may include a cushion. In one embodiment, the frame module 34 may include a fabric slip cover that covers all or part of the module wherein the fabric may be made of an appropriate material for indoor or outdoor use.

FIGS. 3A-3C show one embodiment of the present invention, on which one of the modular components may be a back rest module 36. The back rest module 36 may be configured to provide lateral support to the user sitting on the modular furniture assembly. The back rest module 36 may be placed next to the backside of the base module 32. In one embodiment, the back rest module 36 may have a curved shape. The back rest module 36 may be made of a material suitable for furniture construction. In one embodiment, the back rest module 36 may be made of wood, plastic, metal, composite, or recycled material. In one embodiment, the back rest module 36 may include a back rest cushion 16. In one embodiment the back rest module 36 may include shelves. In one embodiment, the back rest module 36 may include a fabric slip cover that covers all or part of the module wherein the fabric may be made of an appropriate material for indoor or outdoor use.

FIGS. 4A-4C show one embodiment of the present invention, in which one of the modular components may be an arm rest module 38. The arm rest module 38 may be configured to provide support to the arms of the user when connected to the base module 32. The arm rest module 38 may be made of a rigid material suitable for furniture construction. In one embodiment, the arm rest 38 may be made of wood, plastic, metal, composite, or recycled material. The arm rest module 38 may be placed on any side of the base module 32 to form different furniture designs. In one embodiment, the arm rest module 38 may include shelves. In one embodiment, the arm rest module 38 may include an arm rest cushion 18. In one embodiment, the arm rest module 38 may have a curved shape. In one embodiment, the arm rest module 38 may include a fabric slip cover that covers all or part of the module wherein the fabric may be made of an appropriate material for indoor or outdoor use.

FIGS. 5A-5C show one embodiment of the present invention, in which one of the modular components may be a leg rest module 10. The leg rest module 10 may be configured to provide support to the legs of the user when connected to the base module 32. The leg module 10 may be made of a material suitable for furniture construction. In one embodiment, the leg rest 10 may be made of wood, plastic, metal, composite, or recycled material. The leg rest module 10 may be placed on the front of the base module 32 to form different furniture designs. In one embodiment, the leg rest module 10 may have a curved shape. In one embodiment, the leg rest module 10 may include a leg rest cushion 20. In one embodiment, the leg rest module 10 may include a fabric slip cover that covers all or part of the module wherein the fabric may be made of a material for indoor or outdoor use.

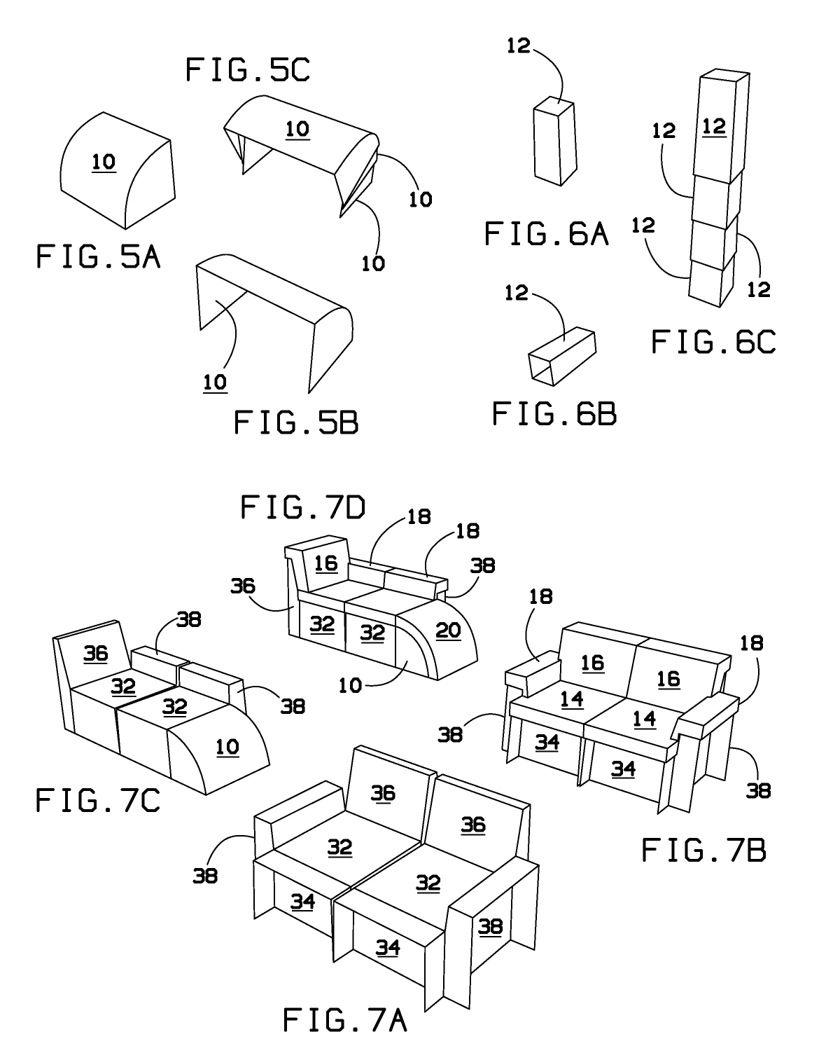

FIGS. 6A-6C show one embodiment of the present invention, in which one of the modular components may be a filler module 12. The filler module 12 may be configured to fill out empty spaces between the modules as needed. The filler module 12 may be made of a material suitable for furniture construction. In one embodiment, the filler module 12 may be made of wood, plastic, metal, composite, or recycled material. In one embodiment, the filler module 10 may include a fabric slip cover that covers all or part of the module wherein the fabric may be made of an appropriate material for indoor or outdoor use.

The modules may be placed one next to each other. In one embodiment, the modules may be connected to each other by using quick acting fasteners that allow the easy assembling and disassembling of the modules with minimal effort and without the use of a tool. In one embodiment, the quick acting fastener may be hook and loop fastener, female and male interconnections, nut and bolt fasteners, clips, or adhesive tape. In one embodiment, the modules may be permanently attached by using screws, rivets, chemical welding, or adhesives.

The attachment sides of each one of the modules 34, 36, 38 and 10 may be designed to match the sides of the base module 32 and 12 so the full contact of these surface areas allows for a tight bond between the modules and a strong and stable final assembly. In one embodiment, the modules may have tapering vertical sides to allow for nested stacking. The degree of slope may be matched on all of the other modules to allow for the entire surface of one side of the module to be coplanar and in full contact with one entire side of the other modules. Therefore, the components may be attached to each other in a number of ways.

The cushions 14, 16, 18, and 20 may be specifically designed to be used with the corresponding module. The cushions may come in a choice of fabrics, colors, cushion densities and other properties appropriate for their intended use either indoors or outdoors.

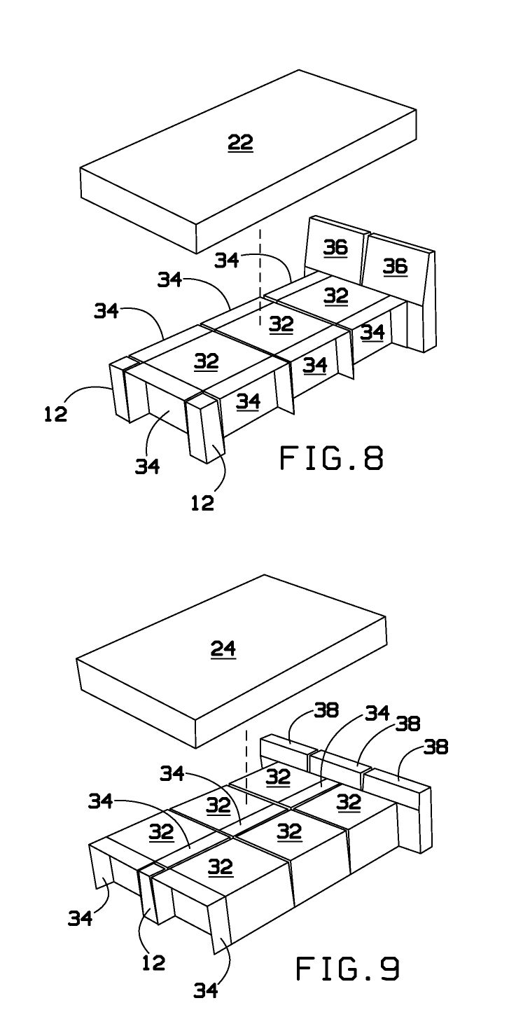

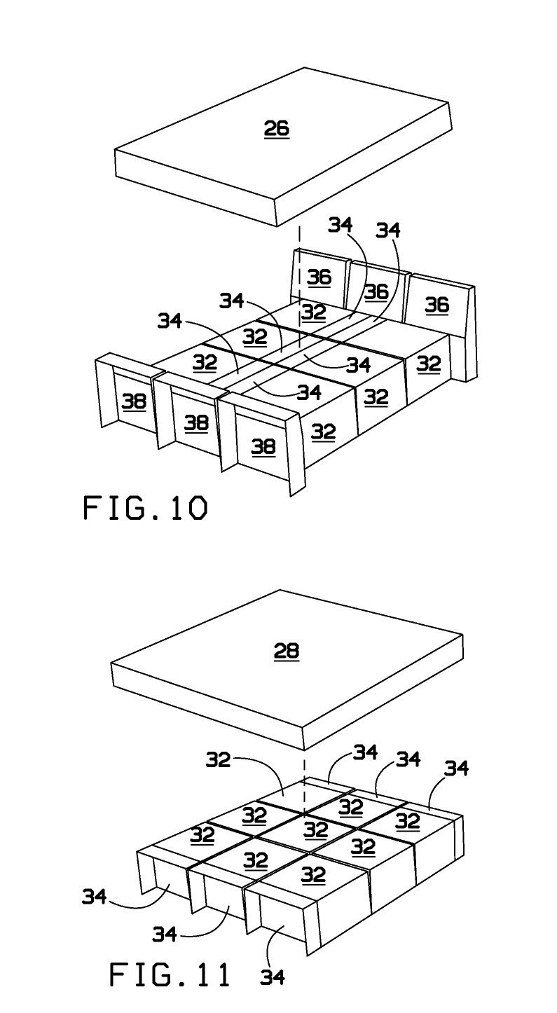

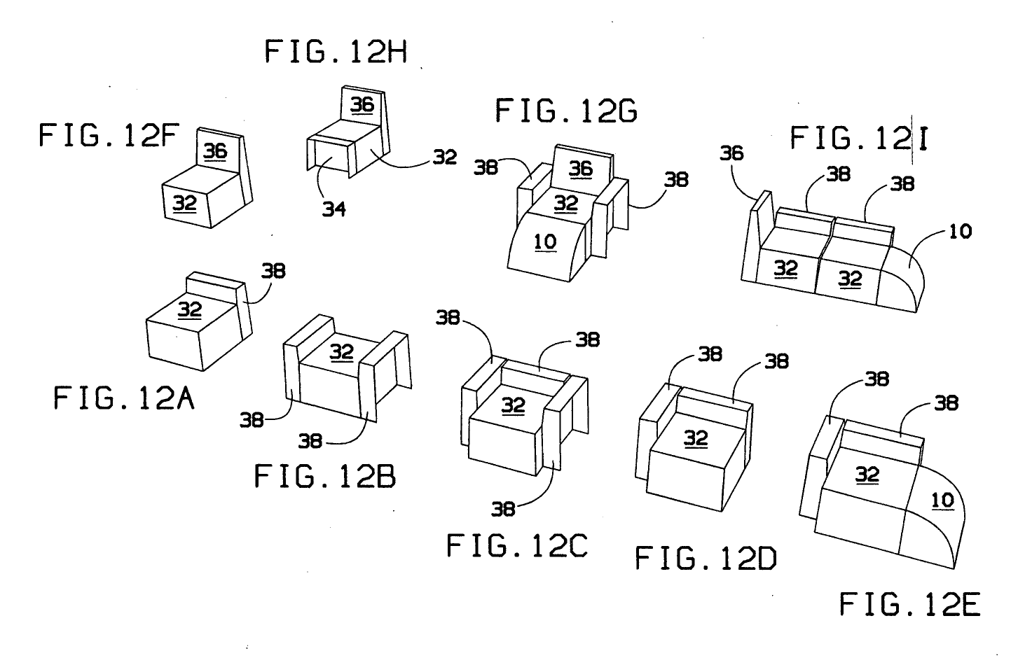

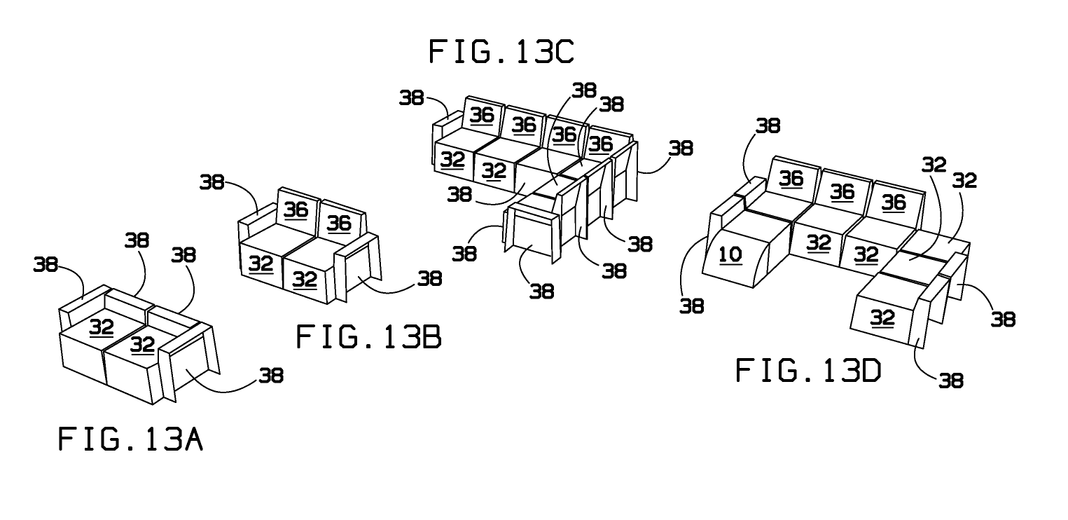

FIGS. 7A-13D represent different furniture arrangements, which can be created from combining the modules of the present invention. These examples only show some of the configuration possibilities. The users may be limited only by their imagination.

To change the design of the furniture from one type of furniture to another, the user manually rearranges the modules to the desired design. In one embodiment, the same modules that formed a couch may be converted to form different types of modular furniture. For example, the modules that formed a couch may be converted, with additional modules, to hold a twin sized mattress 22, a full sized mattress 24, a queen sized mattress 26, or a king sized mattress 28. Another example, the modules that formed a couch may be converted to a chair and a chaise lounge.

In one embodiment, the modular furniture may be used outdoors. In one embodiment, the modular furniture may be used indoors.

In one embodiment, the modules may be interchangeable.

It should be understood, of course, that the foregoing relates to exemplary embodiments of the invention and that modifications may be made without departing from the spirit and scope of the invention as set forth in the following claims.

We claim:

1. A modular furniture assembly comprising:
at least two modules, each module having a shape, a top end, a bottom end, and sides;
wherein the modules interconnect to each other by using a quick acting fastener.

2. The modular furniture assembly of claim 1, wherein the sides of the module include tapering vertical walls and wherein the module are stackable.

3. The modular furniture assembly of claim 1, wherein the modules have the same shape.

4. The modular furniture assembly of claim 1, wherein the modules have different shapes.

5. The modular furniture assembly of claim 1, wherein the shape of the modules is selected from the group consisting of a base, a frame, an arm rest, a back rest, and a leg rest.

6. The modular furniture assembly of claim 1, wherein the modular furniture assembly is selected from the group consisting of a couch, a bed, an ottoman, a chaise lounge, and a chair.

7. The modular furniture assembly of claim 1, further comprising at least one of cushions and slip covers.

8. A modular furniture assembly comprising:
a plurality of modules, each module having a shape, a top end, a bottom end, and sides;
wherein the modules interconnect to each other by using a quick acting fastener; and
wherein the sides of each module matches the sides of the adjacent module forming a tight bond between the modules.

9. The modular furniture assembly of claim 8, wherein the quick acting fastener is selected from the group consisting of hook and loop fasteners, female and male fasteners, nut and bolt fasteners, clips, and adhesive tape.

10. A modular furniture assembly comprising:
a plurality of modules, each module having a shape, a top end, a bottom end, and sides;
wherein the modules are positioned one next to each other;
wherein the sides of each module matches the sides of the adjacent module forming a tight bond between the modules;
wherein the modules are interchangeable.
